(19) United States
(12) Patent Application Publication
(10) Pub. No.: US 2015/0042843 A1
(43) Pub. Date: Feb. 12, 2015

(54) SYSTEMS AND METHODS FOR IMPROVING IMAGES

(71) Applicant: Broadcom Corporation, Irvine, CA (US)

(72) Inventors: Ike Aret IKIZYAN, Newport Coast, CA (US); Noam SOREK, Zichron Yacoov (IL)

(73) Assignee: Broadcom Corporation, Irvine, CA (US)

(21) Appl. No.: 14/020,673

(22) Filed: Sep. 6, 2013

Related U.S. Application Data
(60) Provisional application No. 61/864,333, filed on Aug. 9, 2013.

(51) Int. Cl. H04N 5/232; H04N 9/73

(52) U.S. Cl. CPC H04N 5/23229; H04N 9/735; H04N 5/23222
USPC 348/223.1; 348/241

(57) ABSTRACT

Systems and methods for improving images. In some aspects, a method includes determining an environment associated with a first image. The environment includes at least one of a time and a location. At least one of an image sensor and a light sensor of an imaging device is used to capture the first image. The method also includes automatically acquiring supplemental data based on the determined environment. The supplemental data is external to the image sensor and the light sensor. The method also includes improving at least one of an accuracy and a perceptual quality of the first image based on the automatically acquired supplemental data.

### CROSS-REFERENCES TO RELATED APPLICATIONS

The present application claims the benefit of U.S. Provisional Patent Application Ser. No. 61/864,333, titled “Systems and Methods for Improving Image Accuracy,” filed on Aug. 9, 2013, which is hereby incorporated by reference in its entirety for all purposes.

### FIELD

The subject technology generally relates to imaging and, in particular, relates to systems and methods for improving image accuracy and/or perceptual quality.

### BACKGROUND

Lighting conditions of an environment may affect the way in which an image of the environment is accurately captured or perceived to have good quality. For example, the lighting conditions of the environment may cause colors and/or shading in the environment to be inaccurately reflected in the image. Cameras typically try to correct this problem through processes that utilize data gathered solely from the image sensors and light sensors in the cameras. However, use of the data gathered from the image sensors and the light sensors may not necessarily be reliable and/or may not guarantee that the perceptual quality or accuracy of the images can be improved. Although users may manually provide lighting condition information to the cameras, it may be cumbersome to continuously provide this type of information for each image that is to be captured.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of an imaging device used for capturing images, in accordance with various aspects of the subject technology.

FIG. 2 illustrates an example of a system for improving images, in accordance with various aspects of the subject technology.

FIG. 3 illustrates an example of a method for improving images, in accordance with various aspects of the subject technology.

FIGS. 4A, 4B, 4C, 4D, and 4E illustrate examples of different situations in which the accuracy and/or perceptual quality of a designated image can be improved, in accordance with various aspects of the subject technology.

FIG. 5 conceptually illustrates an electronic system with which aspects of the subject technology may be implemented.

### DETAILED DESCRIPTION

In the following detailed description, numerous specific details are set forth to provide a full understanding of the subject technology. It will be apparent, however, that the subject technology may be practiced without some of these specific details. In other instances, structures and techniques have not been shown in detail so as not to obscure the subject technology.

According to various aspects of the subject technology, systems and methods are provided for improving image accuracy and/or perceptual quality by using supplemental data from sources external to an image sensor and/or a light sensor of an imaging device without requiring users to manually enter this data. The supplemental data, for example, may include lighting condition information retrieved from databases that provide general weather information, color temperature models, images in a similar environment, control setting information of those images, statistical information of those images, and/or any other information that may be used to improve the accuracy and/or perceptual quality of an image that was or will be captured. In some aspects, if the image has not yet been captured, the supplemental data may be used by the imaging device to adjust appropriate control settings (e.g., a color balance setting, a flash setting, an aperture setting, a shutter speed setting, an exposure compensation setting, an ISO setting, a light frequency setting, a noise reduction setting, a sharpening setting, etc.) such that the image can be captured accurately and/or with higher perceptual quality. In some aspects, if the image has already been captured, the supplemental data may be used to adjust the image itself so that it accurately reflects the environment in the image and/or improves the perceptual quality.

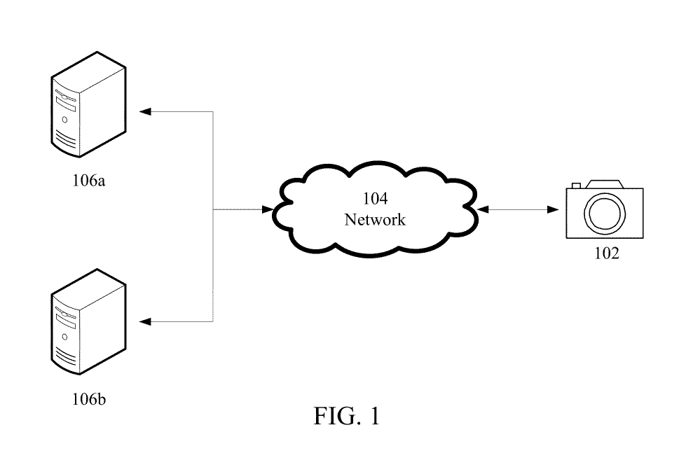

FIG. 1 illustrates an example of imaging device 102 used for capturing images, in accordance with various aspects of the subject technology. Imaging device 102, for example, may include an image sensor and/or a light sensor used to capture images. Although imaging device 102 is shown in FIG. 1 as a standalone camera, it is understood that imaging device 102 may be a general device that can perform other functions in addition to capturing images. For example, imaging device 102 may be a mobile phone, a tablet, a laptop computer, a desktop computer, a personal digital assistant, a video game device, and/or any other device with image capturing capability.

Imaging device 102 may also have the capability to communicate with other devices. For example, as shown in FIG. 1, imaging device 102 and servers 106 (e.g., servers 106a and 106b) are connected over network 104. Network 104 can include, for example, any one or more of a personal area network (PAN), a local area network (LAN), a campus area network (CAN), a metropolitan area network (MAN), a wide area network (WAN), a broadband network (BBN), a peer-to-peer network, an ad-hoc network, the Internet, and the like. Further, network 104 can include, but is not limited to, any one or more network topologies such as a bus network, a star network, a ring network, a mesh network, a star-bus network, tree or hierarchical network, and the like. Servers 106 can be any electronic device having processing hardware, memory, and communications capability to communicate with imaging device 102.

As discussed above, image accuracy and/or perceptual quality can be improved by using supplemental data from sources external to the image sensor and/or the light sensor of imaging device 102. In some aspects, the supplemental data can be stored in imaging device 102 itself (and not provided by and/or derived from the image sensor and/or the light sensor of imaging device 102). For example, the supplemental data may be retrieved from a database stored in imaging device 102. In some aspects, the supplemental data can be retrieved from one or more servers 106 over network 104. For example, the supplemental data can be retrieved from one or more databases stored in servers 106.

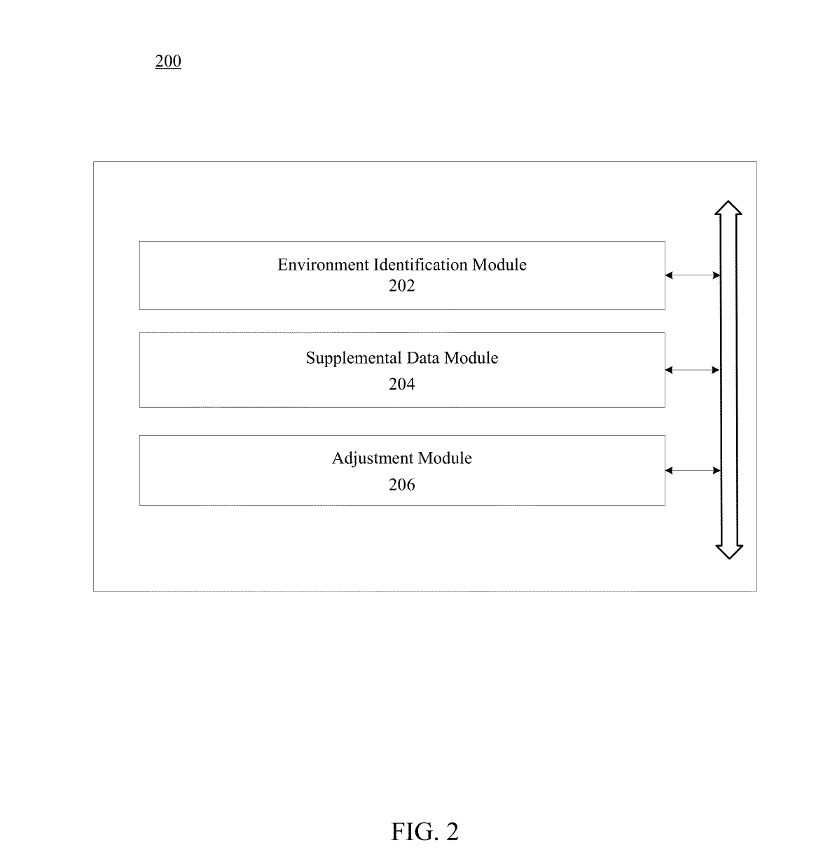

FIG. 2 illustrates an example of system 200 for improving images, in accordance with various aspects of the subject technology. System 200, for example, may be part of imaging device 102, and includes environment identification module 202, supplemental data module 204, and adjustment module 206. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

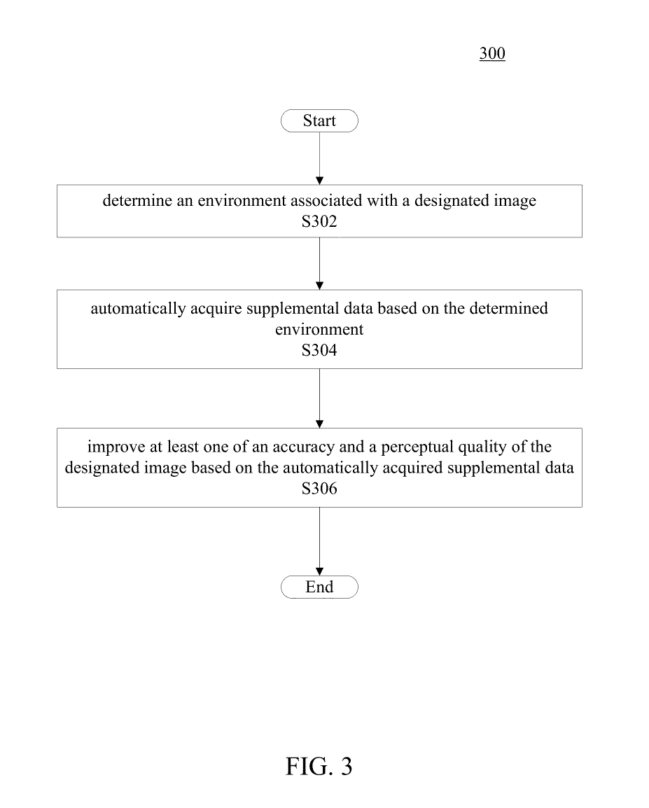

FIG. 3 illustrates an example of method 300 for improving images, in accordance with various aspects of the subject technology. System 200, for example, may be used to implement method 300. However, method 300 may also be implemented by systems having other configurations. Although method 300 is described herein with reference to the examples of FIGS. 1 and 2, method 300 is not limited to these examples. Furthermore, although method 300 is illustrated in the order shown in FIG. 3, it is understood that method 300 may be implemented in a different order.

System 200 may implement method 300 to improve the accuracy and/or perceptual quality of a designated image that was or will be captured by imaging device 102. According to certain aspects, in order to improve the accuracy and/or perceptual quality of the designated image, it may be desirable to determine the environment associated with the designated image so that the lighting condition information of the environment and/or other relevant information can be obtained. In this regard, according to method 300, environmental identification module 202 determines the environment associated with the designated image (S302). The environment may include a time and/or location at which the designated image was or will be captured. The location, for example, may include a position of imaging device 102, an orientation of imaging device 102, an area in a field-of-view of imaging device 102, a position of an entity in the designated image, and/or any place associated with the designated image.

In one or more implementations, environment identification module 202 may determine the environment by using one or more sensors. For example, environment identification module 202 may determine the environment using a global positioning system (GPS) sensor, a Wi-Fi-based positioning system (WPS) sensor, a gyroscopic sensor, an accelerometer, a magnetometer, and/or other sensors. One or more of these sensors may be part of imaging device 102. Environment identification module 202 may also determine the environment by using other sources, such as from the metadata of the designated image (e.g., if the designated image was already captured), a clock of imaging device 102, a clock from servers 106, and/or other sources useful for identifying the environment.

Once the environment has been determined, supplemental data that is relevant to the environment can be acquired. According to method 300, supplemental data module 204 automatically acquires the supplemental data based on the determined environment (S304). This supplemental data may be external to the image sensor and/or the light sensor of imaging device 102. For example, the supplemental data is not provided by or otherwise derived from the image sensor and/or the light sensor in connection with the capture of the designated image.

According to certain aspects, the supplemental data can include any information that may be used to improve the accuracy and/or perceptual quality of the designated image. For example, the supplemental data may include sun color temperature model information associated with the determined environment (e.g., lighting color temperature), sun position information associated with the determined environment, weather information associated with the determined environment (e.g., whether it is cloudy, sunny, snowy, rainy, or clear in the environment), an indication of whether the location is indoor or outdoor, artificial light source information associated with the determined environment (e.g., position and/or type of light sources in buildings or streets that can be gathered from manufacturers, builders, urban planners, city authorities, etc.), a color of an entity in the designated image (e.g., the true color of an object or person in the designated image), and/or any information that can be used to improve image accuracy and/or perceptual quality.

The supplemental data may also include information associated with previous images that were captured at substantially the same time and/or location of the designated image. Since the previous images were captured in a similar environment as the designated image, the information associated with the previous images can provide valuable insight on how to improve the accuracy and/or perceptual quality of the designated image. Such information, for example, can include camera control setting information of the previous images (e.g., a color balance setting, a flash setting, an aperture setting, a shutter speed setting, an exposure compensation setting, an ISO setting, a light frequency setting, a noise reduction setting, a sharpening setting, and/or any camera control setting that may be useful for improving the accuracy and/or perceptual quality of the designated image), statistical information of the previous images, review information of the previous images (e.g., whether the previous images were highly rated in blogs, social networks, image hosting sites, other websites, etc.), and/or other information useful for improving the accuracy and/or perceptual quality of the designated image.

Once the supplemental data has been acquired, adjustment module 206 improves the accuracy and/or perceptual quality of the designated image based on the supplemental data (S306). For example, adjustment module 206 can use the supplemental data to determine what actions may be performed to improve the accuracy and/or perceptual quality of the designated image. In one or more implementations, adjustment module 206 may improve the accuracy and/or perceptual quality of the designated image by adjusting a control setting of imaging device 102 for capturing the designated image (e.g., assuming that the designated image has not yet been captured by imaging device 102). The control setting, for example, includes a color balance setting, a flash setting, an aperture setting, a shutter speed setting, an exposure compensation setting, an ISO setting, and/or any camera control setting that can be adjusted to improve the accuracy and/or perceptual quality of the designated image. According to certain aspects, if the supplemental data includes information associated with previous images that were captured at substantially the same time and/or location of the designated image, adjustment module 206 may improve the accuracy and/or perceptual quality of the designated image by matching the control setting of imaging device 102 with the control setting information of the previous images. In some aspects, the control setting may be adjusted based on illuminant estimation and/or color balance correction that is improved by accurately knowing the lighting conditions from the supplemental data. For example, if the supplemental data indicates a color, intensity, and/or location of a light source, the control setting may be adjusted such that a white balance for the designated image matches the color, intensity, and/or location of the light source. In some cases, if the supplemental data only provides an approximation of the lighting conditions (e.g., a probability of a light source being at a particular location is provided), the control setting may be calculated to match the approximate lighting conditions (e.g., calculate the white balance for the designated image to match the probability of the light source being at the particular location).

In one or more implementations, adjustment module 206 may also improve the accuracy and/or perceptual quality of the designated image by adjusting the designated image itself (e.g., assuming that the designated image was already captured). For example, the lighting, color, contrast, shading, and/or other aspects of the designated image may be adjusted to improve the accuracy and/or perceptual quality of the designated image.

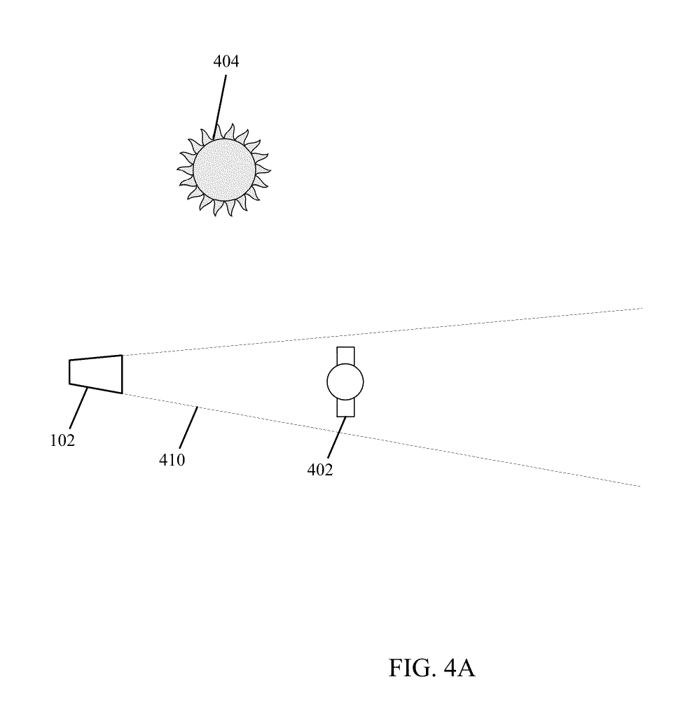

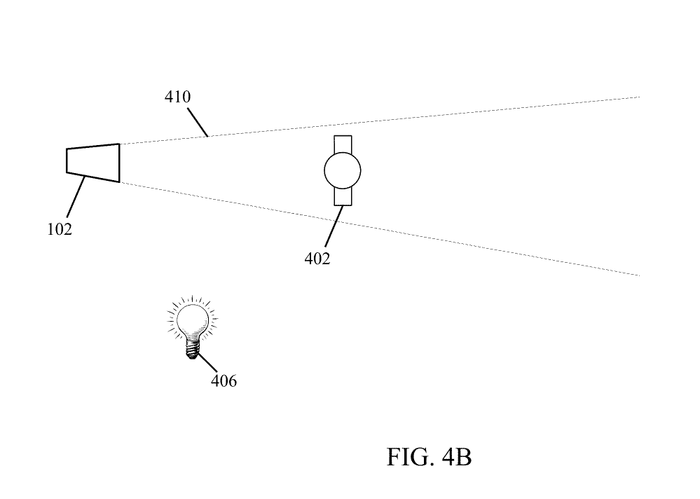

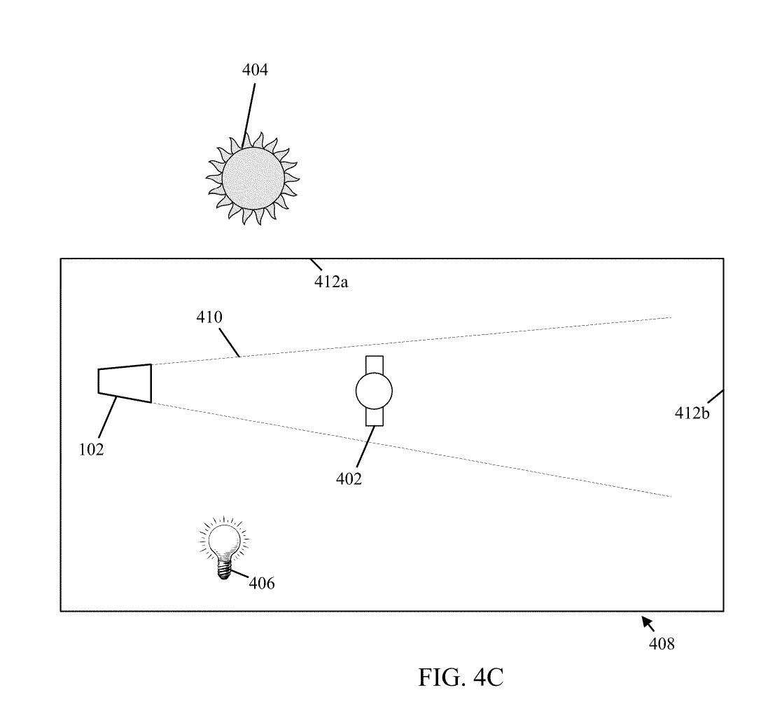

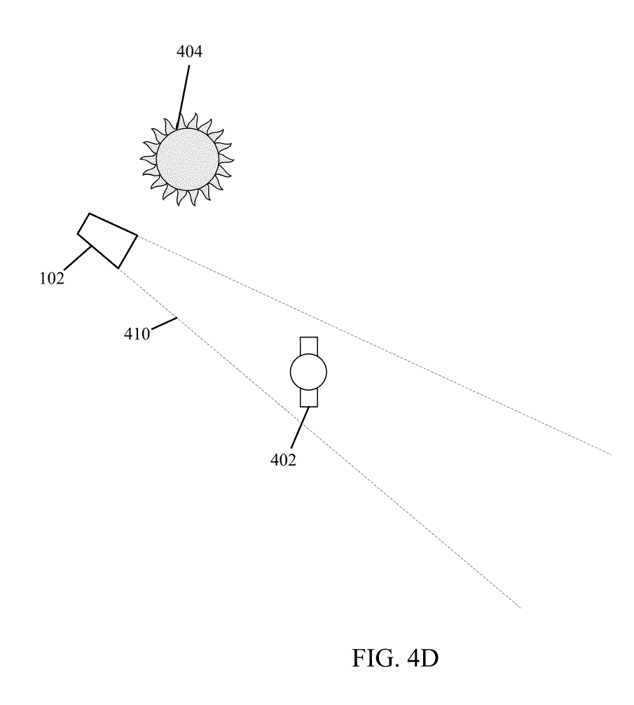

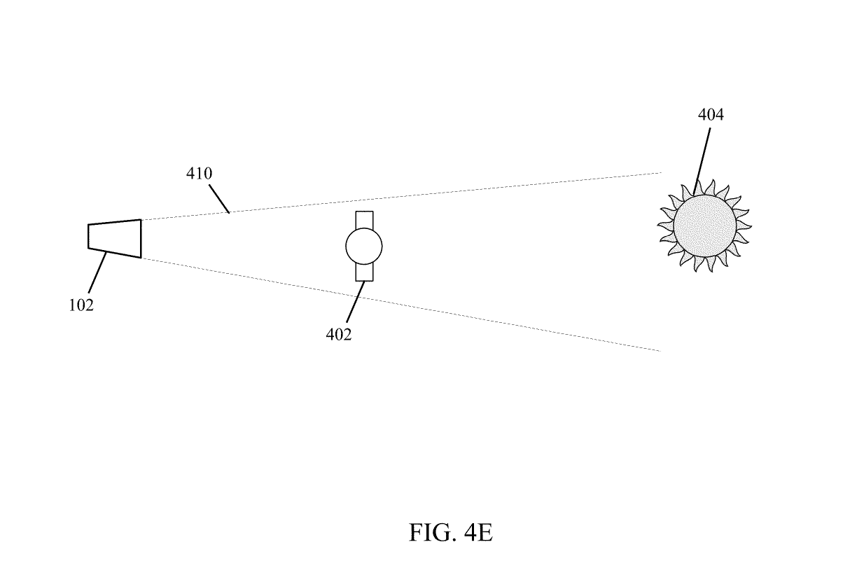

FIGS. 4A, 4B, 4C, 4D, and 4E illustrate examples of different situations in which the accuracy and/or perceptual quality of a designated image can be improved, in accordance with various aspects of the subject technology. FIG. 4A illustrates a top-down view of imaging device 102, person 402, and sun 404 in different positions. Also illustrated in FIG. 4A is field-of-view 410 of imaging device 102, which provides an indication of the designated image that was or will be captured by imaging device 102. Since person 402 is within field-of-view 410 of imaging device 102, the designated image in the situation presented in FIG. 4A may be of person 402.

The supplemental data in the situation for FIG. 4A can include a position of sun 404, a position of imaging device 102, an orientation of imaging device 102, an indication that it is a clear day without any clouds, and a time that the designated image was or will be captured. Since this supplemental data provides lighting condition information relative to the subject in the designated image (e.g., person 402), the accuracy and/or perceptual quality of the designated image can be improved by adjusting the color balance and/or other aspects related to the designated image (e.g., either in adjusting control settings of imaging device 102 to capture the designated image or adjusting the designated image itself in post-capture processing).

FIG. 4B is similar to FIG. 4A, but illustrates artificial light source 406 instead of sun 404. The supplemental data in this situation for FIG. 4B can include a position and a type of artificial light source 406 (e.g., from a database that stores known types of lighting), a position of imaging device 102, an orientation of imaging device 102, and an indication that it is nighttime. Since the supplemental data may indicate nighttime lighting conditions in the environment associated with the designated image, the flash and exposure setting of imaging device 102, the color balance of the designated image, and/or other aspects related to the designated image may be adjusted accordingly, thereby ensuring that person 402 can be captured in the designated image accurately and/or with high perceptual quality.

FIG. 4C is similar to FIGS. 4A and 4B, but illustrates that imaging device 102, person 402, and artificial light source 406 are inside building 408 and that it is daytime with sun 404 providing sunlight outside of building 408. The supplemental data in this situation for FIG. 4C can include an indication that the scene of the designated image is indoor, a position of artificial light source 406, a position of imaging device 102, an orientation of imaging device 102, an indication that wall 412a of building 408 that faces sun 404 does not have windows, and a true color of wall 412b of building 408. Since the supplemental data may indicate indoor lighting conditions and also provides a known color of an object in the designated image, the flash and exposure setting of imaging device 102, the color balance of the designated image, and/or other aspects related to the designated image may be adjusted accordingly to improve the accuracy and/or perceptual quality of the designated image.

FIG. 4D is similar to FIG. 4A, but illustrates imaging device 102 in a different position. The designated image that was or will be captured by imaging device 102 in the situation presented in FIG. 4D may be of the same subject (e.g., person 402) at the same location, but from a different view point and at a later time than the previous image described with respect to FIG. 4A. The supplemental data in this situation for FIG. 4D can include a position of sun 404, a position of imaging device 102, an orientation of imaging device 102, an indication that it is a clear day without any clouds, the time when the designated image was or will be captured, and any information associated with the previous image in FIG. 4A (e.g., camera control setting information of the previous image, statistical information of the previous image, review information of the previous image, and a position and orientation of imaging device 102 when capturing the previous image). Since the supplemental data includes information associated with the previous image, the designated image can be adjusted in a similar manner as the previous image while also accounting for differences in the position and orientation of imaging device 102.

FIG. 4E is similar to FIG. 4A, but illustrates sun 404 in a different position. In particular, sun 404 is positioned behind person 402, and therefore may degrade the designated image as a result of increased back lighting. For example, person 402 may appear dim relative to the background in the designated image because of the sunlight from sun 404. The supplemental data in the situation for FIG. 4E can include a position of sun 404, a position of imaging device 102, an orientation of imaging device 102, an indication that it is a clear day without any clouds, the time when the designated image was or will be captured, and an indication that the light source is behind the subject in the designated image. Since the supplemental data may indicate there may be a backlit problem, the flash and exposure setting of imaging device 102 and other aspects related to the designated image may be adjusted accordingly (e.g., enabling the flash of imaging device 102 and/or boosting the exposure compensation), thereby ensuring that person 402 can be captured in the designated image accurately and/or with high perceptual quality.

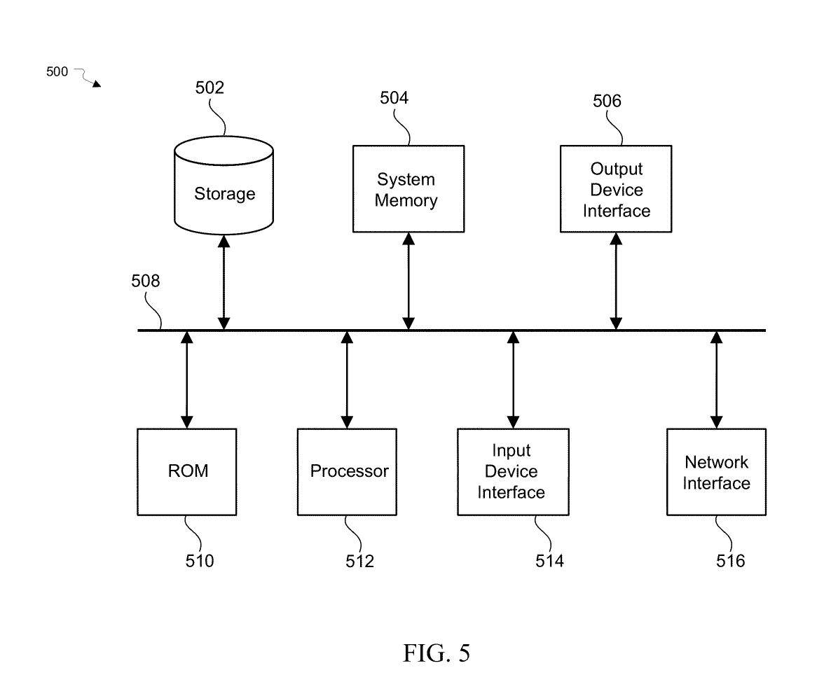

FIG. 5 conceptually illustrates electronic system 500 with which aspects of the subject technology may be implemented. Electronic system 500, for example, can be a desktop computer, a laptop computer, a tablet computer, a server, a phone, a personal digital assistant (PDA), a camera, any device that may be used to improve image accuracy and/or perceptual quality, or generally any electronic device that transmits signals over a network. Such an electronic system includes various types of computer readable media and interfaces for various other types of computer readable media. Electronic system 500 includes bus 508, processing unit(s) 512, system memory 504, read-only memory (ROM) 510, permanent storage device 502, input device interface 514, output device interface 506, and network interface 516, or subsets and variations thereof.

Bus 508 collectively represents all system, peripheral, and chipset buses that communicatively connect the numerous internal devices of electronic system 500. In one or more implementations, bus 508 communicatively connects processing unit(s) 512 with ROM 510, system memory 504, and permanent storage device 502. From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. One or more implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores any of the instructions and data that processing unit(s) 512 needs at runtime. In one or more implementations, the processes of the subject disclosure are stored in system memory 504, permanent storage device 502, and/or ROM 510. From these various memory units, processing unit(s) 512 retrieves instructions to execute and data to process in order to execute the processes of one or more implementations.

Bus 508 also connects to input and output device interfaces 514 and 506. Input device interface 514 enables a user to communicate information and select commands to the electronic system. Input devices used with input device interface 514 include, for example, alphanumeric keyboards and pointing devices (also called “cursor control devices”). Output device interface 506 enables, for example, the display of images generated by electronic system 500. Output devices used with output device interface 506 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, bus 508 also couples electronic system 500 to a network (not shown) through network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While one or more implementations described herein may be software processes executed by microprocessors or multi-core processors, the one or more implementations may also be performed by one or more integrated circuits, such as application specific integrated circuits (ASICs) or field programmable gate arrays (FPGAs). Such integrated circuits, for example, may execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to analyze and control an operation or a component may also mean the processor being programmed to analyze and control the operation or the processor being operable to analyze and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for improving images, the method comprising:
determining an environment associated with a first image, the environment comprising at least one of a time and a location, wherein at least one of an image sensor and a light sensor of an imaging device is used to capture the first image;
automatically acquiring supplemental data based on the determined environment, wherein the supplemental data is external to the image sensor and the light sensor; and
improving at least one of an accuracy and a perceptual quality of the first image based on the automatically acquired supplemental data.

2. The method of claim 1, wherein the location comprises at least one of a position of the imaging device, an orientation of the imaging device, an area in a field-of-view of the imaging device, or a position of an entity in the first image, and wherein the time is when the first image was or will be captured by the image sensor of the imaging device.

3. The method of claim 1, wherein the environment is determined based on at least one of a global positioning system (GPS) sensor, a Wi-Fi-based positioning system (WPS) sensor, a gyroscopic sensor, an accelerometer, a magnetometer, metadata of the first image, a clock of the imaging device, or a clock from a network device to which the imaging device is connected.

4. The method of claim 1, wherein the supplemental data is not provided by the image sensor and the light sensor in connection with the capture of the first image.

5. The method of claim 1, wherein the supplemental data comprises at least one of sun color temperature model information associated with the determined environment, sun position information associated with the determined environment, weather information associated with the determined environment, an indication of whether the location is indoor or outdoor, artificial light source information associated with the determined environment, a color of an entity in the first image, a second image associated with the environment, camera control setting information of the second image associated with the environment, statistical information of the second image associated with the environment, or review information of the second image associated with the environment.

6. The method of claim 5, wherein the second image associated with the environment was previously captured by the image sensor of the imaging device.

7. The method of claim 5, wherein automatically acquiring the supplemental data comprises receiving the supplemental data from a database over a network.

8. The method of claim 1, wherein improving at least one of the accuracy and the perceptual quality of the first image comprises at least one of i) adjusting a control setting of the imaging device for capturing the first image or ii) adjusting the first image.

9. The method of claim 8, wherein the control setting comprises at least one of a color balance setting, a flash setting, an aperture setting, a shutter speed setting, an exposure compensation setting, an ISO setting, a light frequency setting, a noise reduction setting, and a sharpening setting.

10. A system for improving images, the system comprising:
an environment identification module configured to determine an environment associated with a first image, the environment comprising at least one of a time and a location, wherein at least one of an image sensor and a light sensor of an imaging device is used to capture the first image;
a supplemental data module configured to automatically acquire supplemental data based on the determined environment, wherein the supplemental data is external to the image sensor and the light sensor; and
an adjustment module configured to improve at least one of an accuracy and a perceptual quality of the first image based on the automatically acquired supplemental data.

11. The system of claim 10, wherein the environment is determined based on at least one of a global positioning system (GPS) sensor, a Wi-Fi-based positioning system (WPS) sensor, a gyroscopic sensor, an accelerometer, a magnetometer, metadata of the first image, a clock of the imaging device, or a clock from a network device to which the imaging device is connected.

12. The system of claim 10, wherein the supplemental data is not provided by the image sensor and the light sensor in connection with the capture of the first image.

13. The system of claim 10, wherein the supplemental data comprises at least one of sun color temperature model information associated with the determined environment, sun position information associated with the determined environment, weather information associated with the determined environment, an indication of whether the location is indoor or outdoor, artificial light source information associated with the determined environment, a color of an entity in the first image, a second image associated with the environment, camera control setting information of the second image associated with the environment, statistical information of the second image associated with the environment, or review information of the second image associated with the environment.

14. The system of claim 13, wherein the second image associated with the environment was previously captured by the image sensor of the imaging device.

15. The system of claim 13, wherein automatically acquiring the supplemental data comprises receiving the supplemental data from a database over a network.

16. The system of claim 10, wherein improving at least one of the accuracy and the perceptual quality of the first image comprises at least one of i) adjusting a control setting of the imaging device for capturing the first image or ii) adjusting the first image.

17. The system of claim 16, wherein the control setting comprises at least one of a color balance setting, a flash setting, an aperture setting, a shutter speed setting, an exposure compensation setting, an ISO setting, a light frequency setting, a noise reduction setting, and a sharpening setting.

18. A computer program product comprising instructions stored in a tangible computer-readable storage medium, the instructions comprising:
instructions for determining an environment associated with a first image, the environment comprising at least one of a time and a location, wherein at least one of an image sensor and a light sensor of an imaging device is used to capture the first image;
instructions for automatically acquiring supplemental data based on the determined environment, wherein the supplemental data is not provided by the image sensor and the light sensor in connection with the capture of the first image; and
instructions for improving at least one of an accuracy and a perceptual quality of the first image based on the automatically acquired supplemental data,
wherein the instructions for improving at least one of the accuracy and the perceptual quality of the first image comprises at least one of i) instructions for adjusting a control setting of the imaging device for capturing the first image or ii) instructions for adjusting the first image.

19. The computer program product of claim 18, wherein the location comprises at least one of a position of the imaging device, an orientation of the imaging device, an area in a field-of-view of the imaging device, or a position of an entity in the first image, and wherein the time is when the first image was or will be captured by the image sensor of the imaging device.

20. The computer program product of claim 18, wherein the control setting comprises at least one of a color balance setting, a flash setting, an aperture setting, a shutter speed setting, an exposure compensation setting, an ISO setting, a light frequency setting, a noise reduction setting, and a sharpening setting.
